(19) United States
(12) Patent Application Publication
(10) Pub. No.: US 2026/0148016 A1
(43) Pub. Date: May 28, 2026

(54) INFORMATION PROCESSING APPARATUS

(71) Applicant: TOYOTA JIDOSHA KABUSHIKI KAISHA, Toyota-shi (JP)

(72) Inventors: Masayuki OKAMOTO, Nagoya-shi (JP); Koji HETSUGI, Toyota-shi (JP); Naritomo MIURA, Miyoshi-shi (JP); Yosuke UENO, Nagoya-shi (JP); Tatsuya OWASHI, Soka-shi (JP)

(73) Assignee: TOYOTA JIDOSHA KABUSHIKI KAISHA, Toyota-shi (JP)

(21) Appl. No.: 19/385,416

(22) Filed: Nov. 11, 2025

(30) Foreign Application Priority Data
Nov. 28, 2024 (JP) 2024-207775

(51) Int. Cl. G06F 40/40

(52) U.S. Cl. CPC G06F 40/40

(57) ABSTRACT

An information processing apparatus acquires structured data having items and data elements belonging to the items and text information including a description of the structured data, determines whether the description includes an explanation about the items, outputs, to a user, a question regarding a target item that is an item the explanation about which is determined not to be included, acquires a first user response to the question, as learning data for a language model that outputs a response when an inquiry regarding the structured data is input, and updates the language model to adapt to the learning data.

### CROSS-REFERENCE TO RELATED APPLICATION

This application claims priority to Japanese Patent Application No. 2024-207775 filed on Nov. 28, 2024, the entire contents of which are incorporated herein by reference.

### TECHNICAL FIELD

The present disclosure relates to an information processing apparatus.

### BACKGROUND

Systems that recognize table information are known to exist. For example, Patent Literature (PTL) 1 discloses that when a document containing text and a table is input, conceptual relationship and the like between table elements are estimated based on table structure information, table element-related sentences, and rules for estimation of conceptual structure relationship.

### CITATION LIST

### Patent Literature

PTL 1: JP 6168309 B2

### SUMMARY

It is conceivable to estimate relationship between table elements using machine learning. However, when the amount of information on input text is insufficient, sufficient table element-related sentences cannot be extracted, which causes failure in estimation.

It would be helpful to improve technology for learning text about structured data.

An information processing apparatus according to the present disclosure includes a controller configured to:
acquire structured data having at least one item and a data element belonging to the at least one item, and text information including a description of the structured data;
determine whether the description includes an explanation about the at least one item;
output, to at least one user, a question regarding a target item that is an item the explanation about which is determined not to be included;
acquire a first user response to the question, as learning data for a language model that outputs a response when an inquiry regarding the structured data is input; and
update the language model to adapt to the learning data.

According to the present disclosure, technology for learning text about structured data is improved.

### BRIEF DESCRIPTION OF THE DRAWINGS

In the accompanying drawings:

FIG. 1 is a block diagram illustrating a schematic configuration of a system according to an embodiment of the present disclosure; and

FIG. 2 is a flowchart illustrating operations of an information processing apparatus.

### DETAILED DESCRIPTION

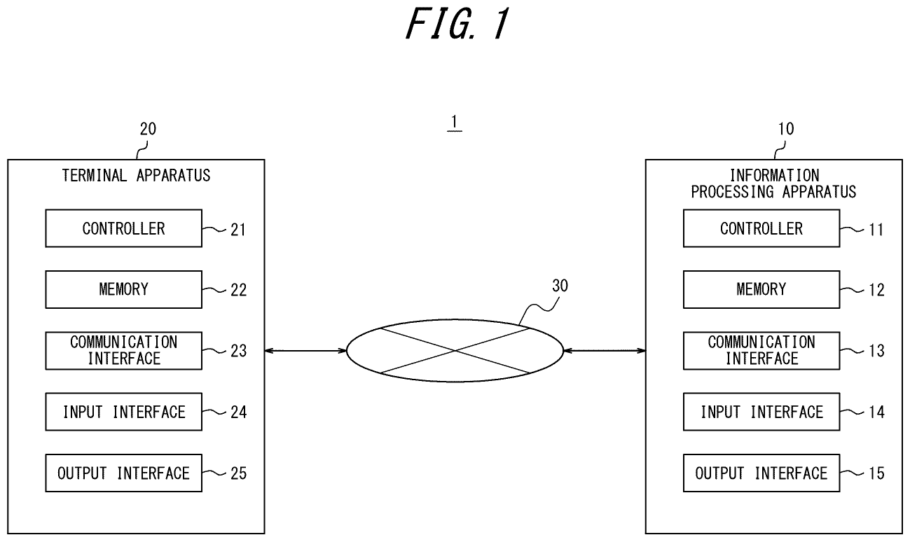

Hereinafter, an embodiment of the present disclosure will be described. A summary and configuration of a system 1 according to the present embodiment will be described with reference to FIG. 1. The system 1 includes an information processing apparatus 10 and a terminal apparatus 20. The information processing apparatus 10 is, for example, a general-purpose computer such as a PC (Personal Computer), a server computer such as a cloud server, or a dedicated computer. The terminal apparatus 20 is any device used by each user. For example, general-purpose electronic devices such as PCs or smartphones, or dedicated electronic devices can be adopted as the terminal apparatus 20. The information processing apparatus 10 is equipped with a language model. The language model includes a Large Language Model (LLM). The language model is created by machine learning using machine learning algorithms. The language model outputs text corresponding to the prompt based on the input of the prompt from the user. The prompt includes inquiries about structured data, and the language model can output answers to those inquiries. The information processing apparatus 10 and the terminal apparatus 20 are communicably connected to a network 30 including, for example, a mobile communication network and the Internet. In FIG. 1, one information processing apparatus 10 and one terminal apparatus 20 are shown, but the system 1 may include multiple such devices.

First, an outline of the present embodiment will be described, and details thereof will be described later. The information processing apparatus 10 acquires structured data that includes items and data elements belonging to those items, as well as text information that includes descriptions of the structured data. The information processing apparatus 10 determines whether the description includes an explanation about the items and outputs questions to the user regarding target items that are determined not to have explanations included. The information processing apparatus 10 acquires a first user response to the question as learning data for the language model and updates the language model to adapt to the learning data.

Structured data includes any data in formats such as CSV (Comma Separated Values) or JSON (JavaScript Object Notation). According to the present embodiment, the language model can be updated using the user's explanations about structured data as additional learning data. This improves the learning accuracy of the language model and enhances the technology for learning text about structured data.

Next, configurations of the information processing apparatus 10 and the terminal apparatus 20 will be described in detail. As shown in FIG. 1, the information processing apparatus 10 includes a controller 11, a memory 12, a communication interface 13, an input interface 14, and an output interface 15. The controller 11 includes at least one processor. The processor is a general purpose processor such as a central processing unit (CPU) or a dedicated processor specialized for specific processing. The controller 11 executes processes related to the operations of the information processing apparatus 10 while controlling the components of the information processing apparatus 10. The memory 12 includes at least one semiconductor memory, for example. The semiconductor memory is, for example, random access memory (RAM) or read only memory (ROM). The memory 12 functions, for example, as a main storage device or auxiliary storage device. The memory 12 stores data to be used for the operations of the information processing apparatus 10 and data obtained by the operations of the information processing apparatus 10. The memory 12 stores a language model. The input interface 14 includes at least one interface for input. The input interface may be, for example, a physical key, a touch screen, or a sound sensor that accepts voice input. The input interface 14 accepts an operation for inputting data to be used for the operations of the information processing apparatus 10. The output interface 15 includes at least one interface for output. The output interface is, for example, a display. The output interface 15 outputs data acquired by the operations of the information processing apparatus 10. The communication interface 13 includes at least one external communication interface. The interface for communication may be either a wired or wireless communication interface. For wired communication, the interface for communication is, for example, a Local Area Network (LAN) or Universal Serial Bus (USB). For wireless communication, the interface for communication is, for example, an interface compatible with mobile communication standards such as 5G or an interface compatible with short-range wireless communication. The communication interface 13 receives data to be used for the operations of the information processing apparatus 10 and transmits data obtained by the operations of the information processing apparatus 10.

As illustrated in FIG. 1, the terminal apparatus 20 includes a controller 21, a memory 22, a communication interface 23, an input interface 24, and an output interface 25. The hardware configurations of the controller 21, communication interface 23, input interface 24, and output interface 25 of the terminal apparatus 20 may be the same as those of the controller 11, communication interface 13, input interface 14, and output interface 15 of the information processing apparatus 10, respectively. A description here is omitted. The memory 22 of the terminal apparatus 20 functions, for example, as a main storage device or auxiliary storage device. The memory 22 stores data to be used for operations of the terminal apparatus 20 and data obtained by the operations of the terminal apparatus 20.

The functions of the information processing apparatus 10 or the terminal apparatus 20 are realized by execution of a program according to the present embodiment by a processor serving as the controller 11 or the controller 21. That is, the functions of the information processing apparatus 10 or the terminal apparatus 20 are realized by software. The program causes a computer to execute the operations of the information processing apparatus 10 or the terminal apparatus 20, thereby causing the computer to function as the information processing apparatus 10 or the terminal apparatus 20. That is, the computer executes the operations of the information processing apparatus 10 or the terminal apparatus 20 in accordance with the program to thereby function as the information processing apparatus 10 or the terminal apparatus 20. In the present embodiment, the program can be recorded on a computer readable recording medium. The computer readable recording medium includes a non-transitory computer readable medium and is, for example, a magnetic recording apparatus, a semiconductor memory, etc. Some or all of the functions of the information processing apparatus 10 or the terminal apparatus 20 may be realized by a dedicated circuit corresponding to the controller 11 or the controller 21. That is, some or all of the functions of the information processing apparatus 10 or terminal apparatus 20 may be realized by hardware.

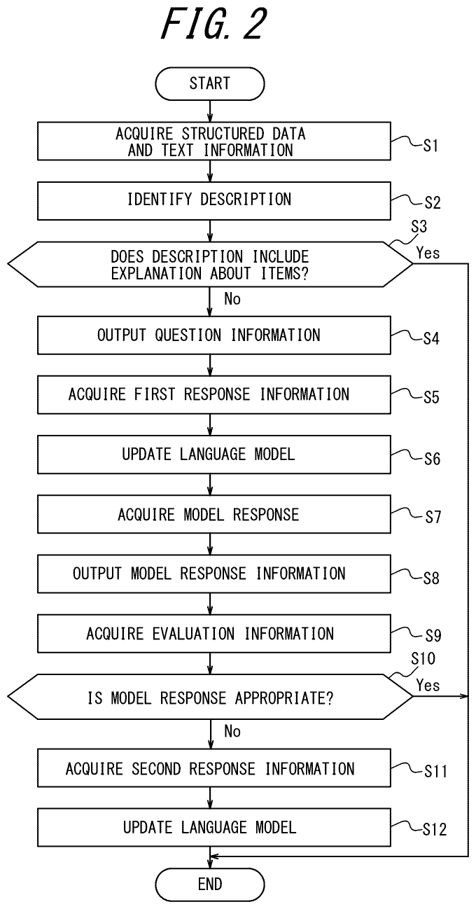

Operations of the information processing apparatus 10 according to the present embodiment will be described with reference to FIG. 2. In the following, communication between the information processing apparatus 10 and an external apparatus is carried out via the communication interface 13 and the network 30. In S1, the controller 11 of the information processing apparatus 10 acquires structured data and text information. The controller 11 may read structured data and text information from the memory 12 or may receive it from an external server apparatus. The controller 11 acquires voice information described regarding the structured data and may obtain text data from the voice information using any voice recognition technology to acquire text information. In this example, the controller 11 reads structured data shown in the following Table 1. Table 1 is an example of structured data that includes multiple items such as name, processing capability, VRAM, and power consumption, along with data elements belonging to each item.

TABLE 1

| | Processing capability | | Power consumption |
|---|---|---|---|
| Name | (TFLOPS) | VRAM(GB) | (W) |
| GPU1 | 312 | 80 | 6500 |
| GPU2 | 150 | 40 | 6400 |

In S2, the controller 11 identifies at least one description included in the text information using any natural language processing technology. In this example, it is assumed that the description “The processing capability of GPU1 is 312 TFLOPS and VRAM is 80 GB. GPU2 has a processing capability of 150, VRAM of 40 GB, and power consumption of 6400 W. The higher the processing capability, the larger the VRAM.” is identified. In S3, the controller 11 determines whether the identified description includes an explanation about items using any natural language processing technology. If it is determined to include an explanation, the operation of the information processing apparatus 10 ends. If it is determined not to include, the operation of the controller 11 proceeds to S4. For example, the controller 11 identifies a predetermined item that serves as an identifier such as a number or name, and determines whether the description identified in S2 includes an explanation about all items contained in the structured data for each data element belonging to the predetermined item. The controller 11 may further determine whether the description identified in S2 includes explanations of the mutual relationships of each item or explanations of the units of each item using any natural language processing technology.

In this example, the controller 11 determines whether the explanations for the data elements “GPU1” and “GPU2” identified as the predetermined item “name” are included in the description. The controller 11 determines that the three explanations regarding “power consumption” for “GPU1”, the unit explanation for the item “processing power” for “GPU2”, and the explanation of the mutual relationship of each item excluding the relationship between “processing power” and “VRAM” are not included in the description identified in S2. Therefore, the operation of the controller 11 proceeds to S4.

In S4, the controller 11 generates question information indicating questions regarding the target items determined not to be included in the description and outputs it via the output interface 15. In this example, the controller 11 outputs question information indicating three questions: “Please tell me the power consumption of GPU1”, “Please tell me the unit of processing power of GPU2”, and “Please tell me the mutual relationships of each item other than the relationship between processing power and VRAM.” The controller 11 may send the question information to each terminal apparatus 20 of multiple users. In S5, the controller 11 acquires first response information indicating the first user response to the question. The first user response is input by a user referring to the structured data. The controller 11 may accept the first user response via the input interface 14. In this example, the controller 11 acquires first response information indicating three first user responses: “The power consumption of GPU1 is 6500 W”, “The unit of processing power of GPU2 is TFLOPS”, and “There is a correlation between processing power and power consumption, and there is no particular relationship between VRAM and power consumption.” The controller 11 may receive first response information indicating the first user responses from each of the multiple terminal apparatuses 20. In this case, the controller 11 may further acquire reason information indicating the reason for the first user response.

In S6, the controller 11 uses the pair of the question generated in S4 and the first user response as learning data to update the language model. In this example, the controller 11 retrains the language model using the three questions mentioned above and their corresponding three first user responses as learning data, updating the parameters of the language model. If the first user responses are obtained from each of the multiple terminal apparatuses 20, the controller 11 may identify the most common first user response as the first common user response using any natural language processing technology and update the language model using the first common user response as learning data. The controller 11 may send information indicating a list of multiple first user responses to each user's terminal apparatus 20. In this case, the relevant information may include reason information related to each user. The controller 11 may accept votes from each terminal apparatus 20 and identify the first user response with the most votes as the first common user response. Blockchain technology or the like may be used for voting. When the information processing apparatus 10 is connected to a learning device as an external device, the controller 11 may output the pair of the question generated in S4 and the first user response or the first common user response as learning data to the learning device, and may further output an instruction to update the parameters of the language model to the learning device.

In S7, the controller 11 inputs a question regarding the target item into the updated language model and acquires a model response that is a response output by the language model. The question may be the same as the question included in the question information generated in S4. In this example, the controller 11 generates the question “What is the power consumption of GPU1?” and inputs it into the language model using any natural language processing technology. The controller 11 acquires the model response “The power consumption of GPU1 is 6400 W” output by the language model. In S8, the controller 11 outputs model response information indicating the model response through the output unit 15. The model response information includes a sentence requesting an evaluation of the response. The controller 11 may send the model response information to each of the terminal apparatuses 20 of multiple users.

In S9, the controller 11 acquires evaluation information indicating user evaluation of the model response. User evaluation is input by users referring to the model response and structured data. User evaluation may be in the form of a score or a sentence. The controller 11 may accept user evaluation via the input unit 14. The controller 11 may receive evaluation information from each of the multiple terminal apparatuses 20. In this case, the controller 11 may further acquire evaluation reason information indicating the reasons for user evaluation. In S10, the controller 11 analyzes the user evaluation and determines whether the model response is appropriate or not. The controller 11 may determine that the model response is appropriate if the score as user evaluation is above a predetermined value, and may determine that it is not appropriate if it is below the predetermined value. The controller 11 may determine that the model response is appropriate when it judges that the user evaluation is positive, and it may determine that the model response is not appropriate when it judges that the user evaluation is negative. If it is judged to be appropriate, the processing of the controller 11 ends. If it is judged to be not appropriate, the processing of the controller 11 proceeds to S11. When multiple user evaluations are obtained, for example, the controller 11 may determine that the model response is appropriate if the number of positive user evaluations for the model response is above a predetermined percentage of the total number of users, or if the total score of the user evaluations is above a predetermined value, and it may determine that the model response is not appropriate if the number of user evaluations is below a predetermined percentage of the total number of users, or if the total score of the user evaluations is below a predetermined value. In this example, the controller 11 acquires evaluation information indicating a user evaluation of ‘This model's response is incorrect’ at S9, and at S10, it determines that the user evaluation is negative using natural language processing technology, concluding that the model response is not appropriate.

At S11, the controller 11 acquires second response information indicating a second user response to modify the model response. The controller 11 may accept the second user response via the input interface 14. The second user response is one that has been re-entered by a user referring to structured data. In this example, the controller 11 acquires second response information indicating a second user response of ‘GPU1 consumes 6500 W.’ The controller 11 may receive the second user response from each of the multiple terminal apparatuses 20 and identify the most common second user response as the second common user response. At S12, the controller 11 updates the parameters of the language model using the pair of the question generated at S4 and the second user response as additional learning data. The controller 11 may update the language model using the second common user response as learning data. Subsequently, the operation of the information processing apparatus 10 ends. Not limited to this, the processing of the controller 11 may return to S7 after S12 and may be repeated until it is determined that the model response is appropriate based on the user evaluation of the output of the updated language model.

As a variation, if the data elements contained in the structured data are missing, if there are outliers in the data elements, or if some data elements do not have units specified, the controller 11 may output data question information to inquire about those data elements. In this case, the controller 11 may acquire user responses regarding the missing data elements themselves, the data elements that substitute for outliers, or the units of the data elements that do not have units specified, and may modify the structured data itself acquired at S1. The controller 11 may acquire user responses indicating the reasons for the missing data, the reasons for being outliers, or the reasons for not having units specified, and may update the language model using the data question information and user responses as learning data.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided. For example, in the above embodiment, it is also possible to implement an embodiment in which the configuration and operations of the information processing apparatus 10 are distributed to multiple computers capable of communicating with each other, including the terminal apparatus 20.

1. An information processing apparatus comprising a controller configured to:
acquire structured data having at least one item and a data element belonging to the at least one item, and text information including a description of the structured data;
determine whether the description includes an explanation about the at least one item;
output, to at least one user, a question regarding a target item that is an item the explanation about which is determined not to be included;
acquire a first user response to the question, as learning data for a language model that outputs a response when an inquiry regarding the structured data is input; and
update the language model to adapt to the learning data.

2. The information processing apparatus according to claim 1, wherein when there is no explanation about a unit of the at least one item in the description, the controller is configured to output, as the question, a question about the unit to the at least one user.

3. The information processing apparatus according to claim 1, wherein
the at least one item is multiple items, and
when there is no explanation about mutual relationship between the multiple items in the description, the controller is configured to output, as the question, a question about the mutual relationship to the at least one user.

4. The information processing apparatus according to claim 1, wherein
the at least one user is multiple users, and
the controller is configured to:
acquire the first user response from each of the multiple users;
identify first user responses common among the multiple users, as a first common user response; and
update the language model using the first common user response.

5. The information processing apparatus according to claim 1, wherein the controller is configured to:
after the language model is updated, input a question about the target item into the language model;
acquire a model response that is a response output by the language model;
output the model response to the user;
acquire a second user response to modify the model response, as additional learning data; and
further updates the language model using the second user response.
